(19) United States
(12) Patent Application Publication
(10) Pub. No.: US 2009/0013834 A1
(43) Pub. Date: Jan. 15, 2009

(54) Multiple-link tool assembly, tool extension, and method

(75) Inventor: Michael Richardson, Charlotte, NC (US)

Correspondence Address: Schwartz Law Firm, P.C.;SouthPark Towers, Suite 1135, 6100 Fairview Road, Charlotte, NC, 28210, US

(73) Assignee: Richardson-Hynes LLC

(21) Appl. No.: 11/825,775

(22) Filed: Jul. 9, 2007

(51) Int. Cl. B25B 23/16; B25B 13/58; B25G 1/06

(52) U.S. Cl. 81/177.8; 81/177.2; 81/180.1

(57) ABSTRACT

A multiple-link tool assembly includes an elongated handle, at least one exchangeable extension link, and an exchangeable tool link. The handle has a portion adapted for being gripped by a user. The exchangeable extension link includes first and second connecting ends, and an angled body intermediate the first and second connecting ends. The first connecting end is removably connected to the handle. The exchangeable tool link has a proximal end removably connected to the second end of the extension link and a fastener-engaging distal end adapted for engaging a threaded fastener.

### TECHNICAL FIELD AND BACKGROUND

The invention in its exemplary embodiments described herein relates broadly to a multiple-link tool assembly, tool extension, and method.

### SUMMARY OF EXEMPLARY EMBODIMENTS

Various exemplary embodiments of the present invention are described below. Use of the term “exemplary” means illustrative or by way of example only, and any reference herein to “the invention” is not intended to restrict or limit the invention to exact features or steps of any one or more of the exemplary embodiments disclosed in the present specification.

It is an object of one or more exemplary embodiments described herein to provide a multiple-link tool assembly capable of extending along a variety of angles in order to reach a fastener which would otherwise be substantially inaccessible using conventional tools. The invention may be assembled in infinitely-variable combinations, and may extend in an interconnected series of relatively soft angles or actuate lengths.

It is another object of one or more exemplary embodiments described herein to provide a method for accessing and operatively engaging a fastener which would otherwise be substantially inaccessible using conventional tools.

It is yet another object of one or more exemplary embodiments described herein to provide a custom-arranged tool extension for use in a multiple-link tool assembly.

These and other objects of the present invention are achieved in the exemplary embodiments disclosed below by providing a multiple-link tool assembly including an elongated handle, at least one exchangeable extension link, and an exchangeable tool link. The handle comprises a portion adapted for being gripped by a user. The exchangeable extension link comprises first and second connecting ends, and an angled body intermediate the first and second connecting ends. The first connecting end is removably connected to the handle. The exchangeable tool link has a proximal end removably connected to the second end of the extension link and a fastener-engaging distal end adapted for engaging a threaded fastener.

According to another exemplary embodiment, the second connecting end of the extension link and the proximal end of the tool link are coaxially arranged. The term “coaxially arranged” means that the connecting ends of adjacent links extend along substantially the same longitudinal axis when the links are assembled together.

According to another exemplary embodiment, the angled body of the extension link defines a radiused bend at an angle selected from a group including substantially 90 degrees, substantially 45 degrees, and substantially 15 degrees.

According to another exemplary embodiment, the bend defined by the angled body has a radius between 0.3 and 0.5 inches.

According to another exemplary embodiment, the first and second connecting ends of the extension link comprise respective male and female connectors integrally formed with the body.

According to another exemplary embodiment, the male connector comprises a multi-walled insert.

According to another exemplary embodiment, the proximal end of the tool link comprises a boxed socket complementary to the multi-walled insert of the extension link, and receiving the multi-walled insert at a selected one of a plurality of available tool orientations. Each tool orientation locates the fastener-engaging end of the tool link at a distinct orientation relative to the handle.

According to another exemplary embodiment, the fastener-engaging distal end of the tool link comprises a wrench.

According to another exemplary embodiment, the first and second connecting ends of the extension link comprise respective multi-walled connectors integrally formed with the body.

According to another exemplary embodiment, the proximal end of the tool link comprises a multi-walled connector complementary to the second end of the extension link, and engaging the second end of the extension link at a selected one of a plurality of available tool orientations. Each tool orientation locates the wrench at a distinct notional plane of engagement.

In another exemplary embodiment, the invention comprises a multiple-link tool assembly including an elongated handle, a custom-configurable tool extension, and an exchangeable tool link. The handle includes a portion adapted for being gripped by a user. The custom-configurable tool extension is removably connected to the handle and comprises a plurality of exchangeable and interconnected extension links. Each extension link has first and second connecting ends, and an angled body intermediate the first and second connecting ends. An exchangeable tool link has a proximal end removably connected to the tool extension, and a fastener-engaging distal end adapted for engaging a threaded fastener.

In yet another exemplary embodiment, the invention comprises a method for accessing and operatively engaging a threaded fastener. The method includes connecting a first angled extension link to an elongated handle of a multiple-link tool assembly. A second angled extension link is then connected to the first angled extension link, such that the first and second extension links form a custom-configurable tool extension. An exchangeable tool link is then connected to the tool extension. The tool link has a fastener-engaging distal end. The fastener-engaging distal end of the tool link is then positioned onto the threaded fastener.

According to another exemplary embodiment, the method includes connecting a third angled extension link to the second angled extension link, such that the first, second, and third extension links form a custom-configurable tool extension.

According to another exemplary embodiment, the method includes arranging the fastener-engaging distal end of the tool link at a selected one of a plurality of available tool orientations.

### BRIEF DESCRIPTION OF THE DRAWINGS

The description of exemplary embodiments proceeds in conjunction with the following drawings, in which:

FIG. 1 is an environmental perspective view of a multi-link tool assembly according to one exemplary embodiment of the present invention;

FIG. 2 is an exploded perspective view of the multi-link tool assembly;

FIGS. 3 and 4 are respective top and side views of one exemplary tool link;

FIGS. 5 and 6 are respective top and side views of a second exemplary tool link;

FIGS. 7, 8, and 9 are side views of exemplary extension links;

FIGS. 10, 11, 12, and 13 are end views of exemplary extension links; and

FIG. 14 is a view of a tool case with its top open to demonstrate storage of various components of the multiple-link tool assembly.

### DESCRIPTION OF EXEMPLARY EMBODIMENTS AND BEST MODE

The present invention is described more fully hereinafter with reference to the accompanying drawings, in which one or more exemplary embodiments of the invention are shown. Like numbers used herein refer to like elements throughout. This invention may, however, be embodied in many different forms and should not be construed as limited to the embodiments set forth herein; rather, these embodiments are provided so that this disclosure will be operative, enabling, and complete. Accordingly, the particular arrangements disclosed are meant to be illustrative only and not limiting as to the scope of the invention, which is to be given the full breadth of the appended claims and any and all equivalents thereof. Moreover, many embodiments, such as adaptations, variations, modifications, and equivalent arrangements, will be implicitly disclosed by the embodiments described herein and fall within the scope of the present invention.

Although specific terms are employed herein, they are used in a generic and descriptive sense only and not for purposes of limitation. Unless otherwise expressly defined herein, such terms are intended to be given their broad ordinary and customary meaning not inconsistent with that applicable in the relevant industry and without restriction to any specific embodiment hereinafter described. As used herein, the article “a” is intended to include one or more items. Where only one item is intended, the term “one”, “single”, or similar language is used. When used herein to join a list of items, the term “or” denotes at lease one of the items, but does not exclude a plurality of items of the list.

For exemplary methods or processes of the invention, the sequence and/or arrangement of steps described herein are illustrative and not restrictive. Accordingly, it should be understood that, although steps of various processes or methods may be shown and described as being in a sequence or temporal arrangement, the steps of any such processes or methods are not limited to being carried out in any particular sequence or arrangement, absent an indication otherwise. Indeed, the steps in such processes or methods generally may be carried out in various different sequences and arrangements while still falling within the scope of the present invention.

Additionally, any references to advantages, benefits, unexpected results, or operability of the present invention are not intended as an affirmation that the invention has been previously reduced to practice or that any testing has been performed. Likewise, unless stated otherwise, use of verbs in the past tense (present perfect or preterite) is not intended to indicate or imply that the invention has been previously reduced to practice or that any testing has been performed.

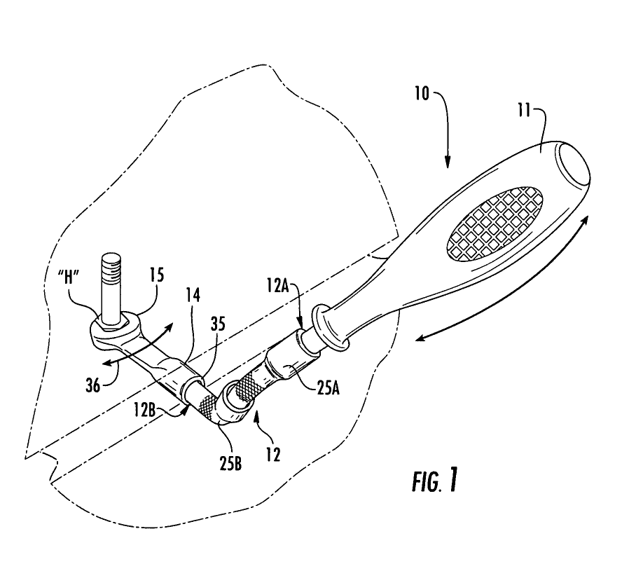

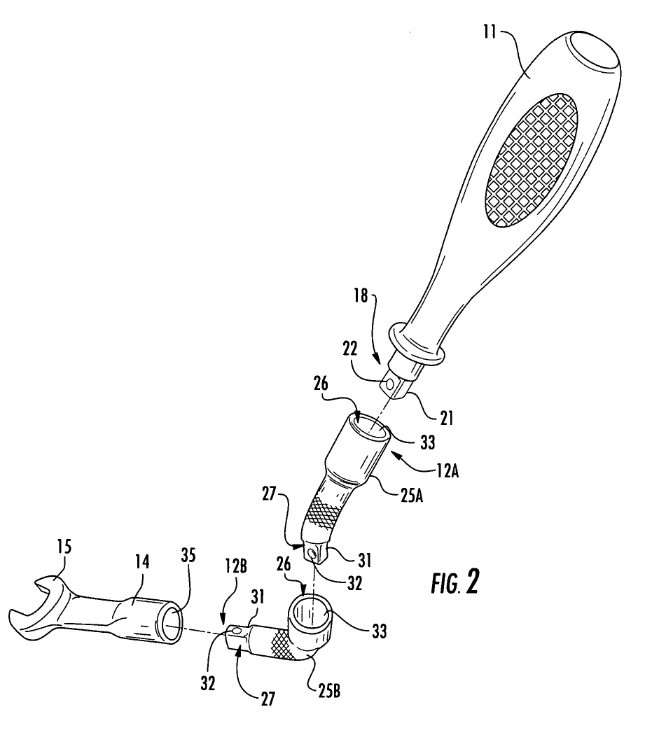

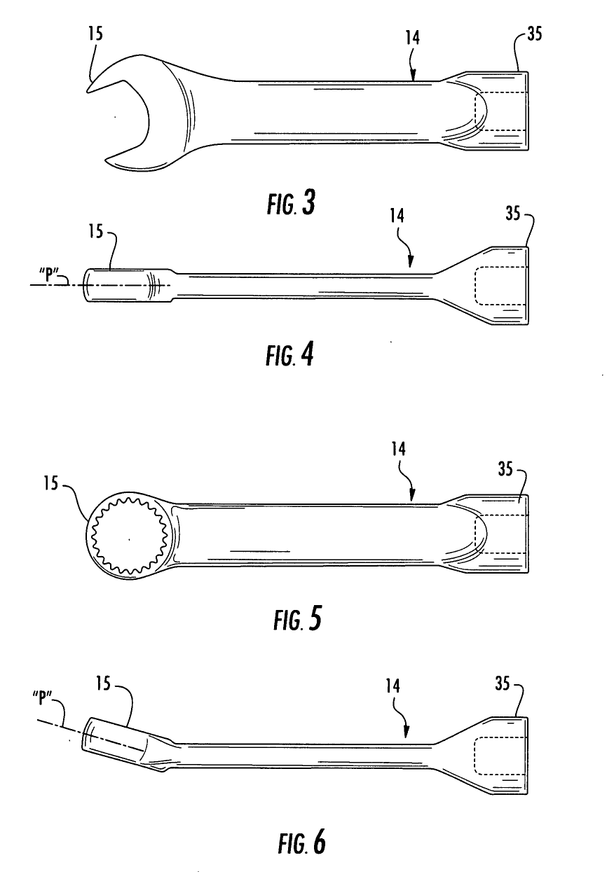

Referring now specifically to the drawings, a multiple-link tool assembly according to one exemplary embodiment of the present invention is illustrated in FIG. 1 and shown generally at reference numeral 10. In the embodiment of FIGS. 1 and 2, the tool assembly 10 comprises a handle 11, a custom-configurable tool extension 12 connected to the handle 11, and an exchangeable tool link 14 connected to the extension 12. The tool link 14 has a fastener-engaging end 15 comprising, for example, an open-end wrench, as shown in FIGS. 3 and 4, or a box-end wrench, as shown in FIGS. 5 and 6. Other common tool ends including (but not limited to) socket wrenches, ratcheting box-end wrenches, flat head screw drivers, Phillips head screw drivers, and the like are also contemplated herein.

The handle 11 has a textured grip portion, and a proximal connecting end 18 shown in FIG. 2. The connecting end 18 comprises a square-shaped fitting 21 or other multi-walled male insert (or “drive”), opposing ball detents 22, and an internal spring (not shown). The square fitting 21 may be, for example, a common ¼ inch, ⅜ inch, ½ inch, or ¾ inch drive. For tool links 14 comprising flat or Phillips head screw drivers, the handle 11 may also incorporate an internal ratcheting mechanism.

As shown in FIGS. 1 and 2, the tool extension 12 comprises one or more exchangeable extension links 25A, 25B. Each extension link 25A, 25B has first and second connecting ends 26, 27, and an arcuate textured body 28 intermediate the first and second connecting ends. The connecting ends 26, 27 may form respective male and female connectors; the male connector comprising a square fitting 31 with opposing spring-loaded ball detents 32, and the female connector comprising a complementary square socket 33. In the implementation shown, the tool extension 12 is assembled by mating the square fitting 31 and socket 33 of the adjacent extension links 25A, 25B. Of course, any number of extension links may be readily assembled in a like manner to custom-configure the tool extension 12 to serve any particular need or maneuver any given obstacle.

Once assembled as desired, a proximal end 12A of the extension link 12 (defining a socket in this case) is releasably mated with the square fitting 21 of the handle 11. Construction of the multi-link tool assembly 10 is then completed by connecting a proximal socket end 35 of the tool link 14 to the distal end 12B of the tool extension 12. The fastener-engaging end 15 of the tool link 14 defines a notional plane of engagement “P” (See FIGS. 4 and 6) which aligns with the head “H” of the fastener (or nut), as shown in FIG. 1, to operatively engage the fastener for rotation as indicated at arrow 36.

FIGS. 7, 8, and 9 show various exemplary embodiments of extension links 25A′, 25B′, and 25C′. The extension link 25A′ of FIG. 7 has first and second connecting ends 26, 27, and an arcuate textured body 28 intermediate the first and second connecting ends, as previously described. The connecting ends form respective male and female connectors; the male connector comprising a square fitting 31 with opposing spring-loaded ball detents 32, and the female connector comprising a complementary square socket 33. The arcuate body of the link defines an angle of approximately 90 degrees with a bend radius of between 0.3 and 0.5 inches.

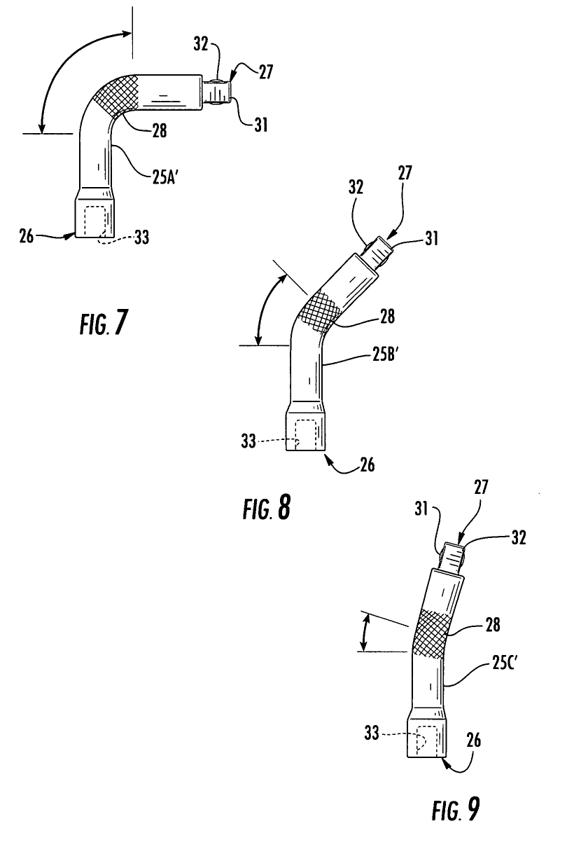

The extension link 25B′ of FIG. 8 has first and second connecting ends 26, 27, and an arcuate textured body 28 intermediate the first and second connecting ends, as previously described. The connecting ends form respective male and female connectors; the male connector comprising a square fitting 31 with opposing spring-loaded ball detents 32, and the female connector comprising a complementary square socket 33. The arcuate body of the link defines an angle of approximately 45 degrees with a bend radius of between 0.3 and 0.5 inches.

The extension link 25C′ of FIG. 9 has first and second connecting ends 26, 27, and an arcuate textured body 28 intermediate the first and second connecting ends. The connecting ends form respective male and female connectors; the male connector comprising a square fitting 31 with opposing spring-loaded ball detents 32, and the female connector comprising a complementary square socket 33. The arcuate body of the link defines an angle of approximately 15 degrees with a bend radius of between 0.3 and 0.5 inches.

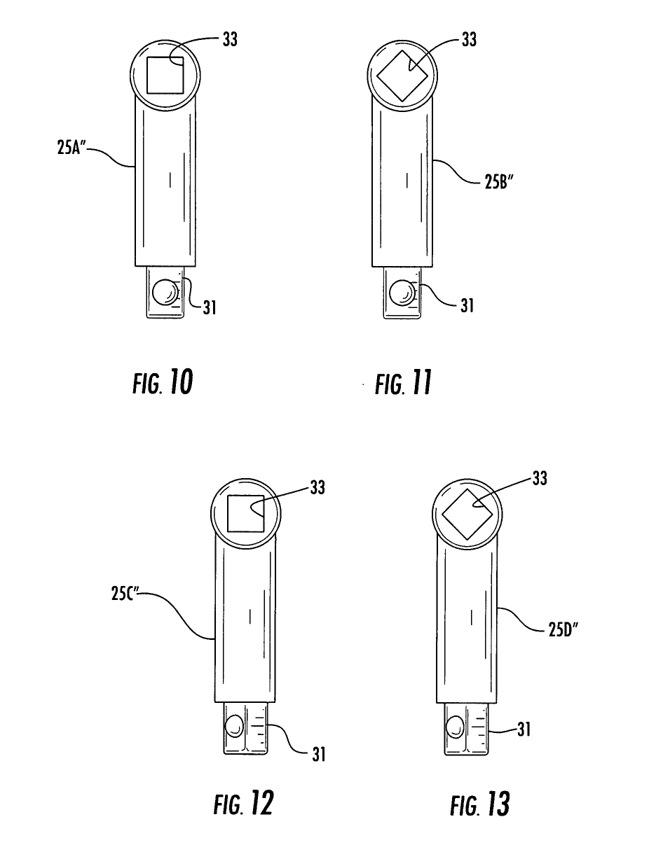

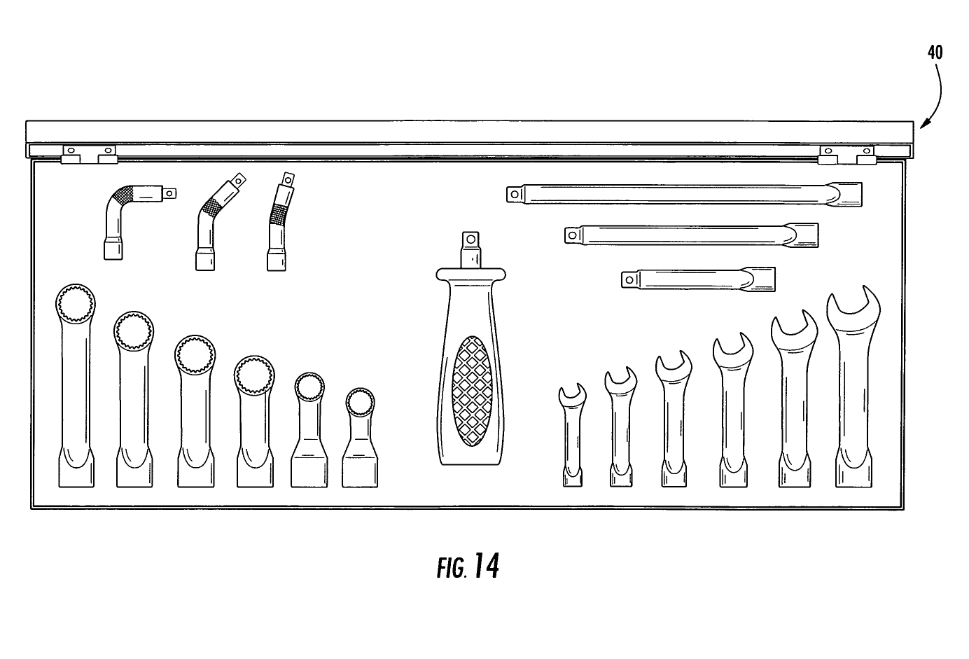

Referring to FIGS. 10-13, for added customization certain extension links 25A″, 24B″, 25C″, and 25D″ may have square fittings 31 and/or sockets 33 which are formed at different orientations. For example, the extension links 25A″&25C″ and 25B″&25D″ shown in FIGS. 10&12 and FIGS. 11&13, respectively, are otherwise identical except for the different orientation of the square fittings 31 (compare FIGS. 10&12 and FIGS. 11&13). Additionally, in an alternative implementation, the square fitting and/or socket may be rotatably adjusted or indexed between multiple, releasably-lockable positions. The different orientations of the sockets and/or fittings allow added unique configurations of the tool extension, and further options for locating the notional plane of engagement defined by the fastener-engaging end of the tool link.

For convenience transport and storage, the various components of multi-link tool assembly 10 may be housed in single tool case 40. The tool case 40 may define recessed beds for each of the different components, including the handle, angled extension links, straight extensions links, and tool links.

Exemplary embodiments of the present invention are described above. No element, act, or instruction used in this description should be construed as important, necessary, critical, or essential to the invention unless explicitly described as such. Although only a view of the exemplary embodiments have been described in detail herein, those skilled in the art will readily appreciate that many modifications are possible in these exemplary embodiments without materially departing from the novel teachings and advantages of this invention. Accordingly, all such modifications are intended to be included within the scope of this invention as defined in the appended claims.

In the claims, any means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. Unless the exact language “means for” (performing a particular function or step) is recited in the claims, a construction under §112, 6th paragraph is not intended. Additionally, it is not intended that the scope of patent protection afforded the present invention be defined by reading into any claim a limitation found herein that does not explicitly appear in the claim itself.

I claim:

1. A multiple-link tool assembly, comprising:
an elongated handle comprising a portion adapted for being gripped by a user;
an exchangeable extension link comprising first and second connecting ends, and an angled body intermediate the first and second connecting ends, the first connecting end being removably connected to said handle; and
an exchangeable tool link having a proximal end removably connected to the second end of said extension link and a fastener-engaging distal end adapted for engaging a threaded fastener.

2. A multiple-link tool assembly according to claim 1, wherein the second connecting end of said extension link and the proximal end of said tool link are coaxially arranged.

3. A multiple-link tool assembly according to claim 1, wherein the angled body of said extension link defines a radiused bend at an angle selected from a group consisting of substantially 90 degrees, substantially 45 degrees, and substantially 15 degrees.

4. A multiple-link tool assembly according to claim 3, wherein the bend defined by said angled body has a radius between 0.3 and 0.5 inches.

5. A multiple-link tool assembly according to claim 1, wherein the first and second connecting ends of said extension link comprise respective male and female connectors integrally formed with said body.

6. A multiple-link tool assembly according to claim 5, wherein said male connector comprises a multi-walled insert.

7. A multiple-link tool assembly according to claim 6, wherein the proximal end of said tool link comprises a boxed socket complementary to the multi-walled insert of said extension link, and receiving the multi-walled insert at a selected one of a plurality of available tool orientations, whereby each tool orientation locates the fastener-engaging end of said tool link at a distinct orientation relative to said handle.

8. A multiple-link tool assembly according to claim 1, wherein the fastener-engaging distal end of said tool link comprises a wrench.

9. A multiple-link tool assembly according to claim 8, wherein the first and second connecting ends of said extension link comprise respective multi-walled connectors integrally formed with said body.

10. A multiple-link tool assembly according to claim 9, wherein the proximal end of said tool link comprises a multi-walled connector complementary to the second end of said extension link, and engaging the second end of said extension link at a selected one of a plurality of available tool orientations, whereby each tool orientation locates said wrench at a distinct notional plane of engagement.

11. A multiple-link tool assembly, comprising:
an elongated handle comprising a portion adapted for being gripped by a user;
a custom-configurable tool extension removably connected to said handle and comprising a plurality of exchangeable and interconnected extension links, each extension link comprising first and second connecting ends, and an angled body intermediate the first and second connecting ends;
an exchangeable tool link having a proximal end removably connected to said tool extension, and a fastener-engaging distal end adapted for engaging a threaded fastener.

12. A multiple-link tool assembly according to claim 11, wherein a distal end of said tool extension and the proximal end of said tool link are coaxially arranged.

13. A multiple-link tool assembly according to claim 11, wherein the angled body of at least one extension link defines a radiused bend at an angle selected from a group consisting of substantially 90 degrees, substantially degrees, and substantially 15 degrees.

14. A multiple-link tool assembly according to claim 13, wherein the bend defined by said angled body has a radius between 0.3 and 0.5 inches.

15. A multiple-link tool assembly according to claim 11, wherein the fastener-engaging distal end of said tool link comprises a wrench.

16. A multiple-link tool assembly according to claim 15, wherein a distal end of said tool extension comprises multi-walled connector.

17. A multiple-link tool assembly according to claim 16, wherein the proximal end of said tool link comprises a multi-walled connector complementary to the multi-walled connector of said tool extension, and engaging the distal end of said tool extension at a selected one of a plurality of available orientations, whereby each tool orientation locates said wrench at a distinct notional plane of engagement.

18. A method for accessing and operatively engaging a threaded fastener, said method comprising:
connecting a first angled extension link to an elongated handle of a multiple-link tool assembly;
connecting a second angled extension link to the first angled extension link, such that the first and second extension links form a custom-configurable tool extension;
connecting an exchangeable tool link to the tool extension, the tool link having a fastener-engaging distal end; and
positioning the fastener-engaging distal end of the tool link onto the threaded fastener.

19. A method according to claim 18, and comprising connecting a third angled extension link to the second angled extension link, such that the first, second, and third extension links form a custom-configurable tool extension.

20. A method according to claim 18, and comprising arranging the fastener-engaging distal end of the tool link at a selected one of a plurality of available tool orientations.
